(19) United States
(12) Patent Application Publication
(10) Pub. No.: US 2014/0012650 A1
(43) Pub. Date: Jan. 9, 2014

(54) METHODS FOR COMMUNITY-BASED CUSTOMER REWARDS MANAGEMENT

(71) Applicant: Jatin Patro, Beaverton, OR (US)

(72) Inventor: Jatin Patro, Beaverton, OR (US)

(21) Appl. No.: 13/543,551

(22) Filed: Jul. 6, 2012

(51) Int. Cl. G06Q 30/02

(52) U.S. Cl. 705/14.27

(57) ABSTRACT

Methods for distributing rewards to buyers purchasing products on online marketplaces, including providing a rewards servers storing community ledgers and seller ledgers, receiving orders from buyers to sellers, receiving from sellers selections of either community-directed awards or seller-directed awards, incrementing seller-specific point balances if sellers selected seller-directed awards, and incrementing community-wide point balances if the seller selected community-directed awards. Some examples may include only community ledgers and no seller ledgers. Some examples may additionally or alternatively include reading scanned identification data with a community identification reader.

### BACKGROUND

The present disclosure relates generally to methods for community-based customer rewards management. In particular, community-based rewards management methods implemented on computing devices are described.

Known rewards management systems are not entirely satisfactory for the range of applications in which they are employed. For example, many existing rewards management systems are operated by individual retailers, wherein rewards accumulation and redemption are handled with respect to only that retailer. Such systems fail to provide the shared marketing potential of retailers grouping together in communities and creating community-based rewards systems. This may be particularly useful for communities that share a common interest, such as those established by chambers of commerce spurring local business or other similar groups.

Further, many conventional rewards management systems do not adequately interface with online marketplaces geared towards local retailers. By interfacing rewards management systems with such online marketplaces, retailers may be provided with easily customizable rewards systems that are easy to administrate. Many locally-focused retailers are forced to create unwieldy rewards systems from scratch; many adopt systems implementing physical rewards cards and punch cards. Such existing systems lack the automation, ease of creation, or ease of use of rewards systems operated through an online marketplace. Further, rewards systems that incorporate physical means (such as the aforementioned punch cards) are very difficult to adapt to an online marketplace, whereas electronically administered rewards may be easily applied to both contexts.

Disclosure addressing one or more of the identified existing needs is provided in the detailed description below. References relevant that share a unity of ownership with this application include U.S. patent References: patent application Ser. No. 13/086,112, patent application Ser. No. 13/355,384, and patent application Ser. No. 13/371,216. The complete disclosures of the above patent applications are herein incorporated by reference for all purposes.

### SUMMARY

The present disclosure is directed to methods for distributing rewards to buyers purchasing products on online marketplaces, including providing a rewards servers storing community ledgers and seller ledgers, receiving orders from buyers to sellers, receiving from sellers selections of either community-directed awards or seller-directed awards, incrementing seller-specific point balances if sellers selected seller-directed awards, and incrementing community-wide point balances if the seller selected community-directed awards. Some examples may include only community ledgers and no seller ledgers. Some examples may additionally or alternatively include reading scanned identification data with a community identification reader.

### BRIEF DESCRIPTION OF THE DRAWINGS

FIG. 1 is a schematic view of an example of a computer system that may be used to implement the disclosed methods.

FIG. 2 is a flow diagram of a first example of a method for community-based customer rewards management.

FIG. 3 is a diagrammatic view of data hosted by an example of a rewards server used in connection with the method shown in FIG. 2.

FIG. 4 is a screenshot of an example of a rewards management form used in connection with the method shown in FIG. 2.

FIG. 5 is a screenshot showing an example of a product page hosted on an online marketplace implementing features of the method shown in FIG. 2.

FIG. 6 is a screenshot of an example of a buyer award management form hosted on an online marketplace implementing features the method shown in FIG. 2.

FIG. 7 is a screenshot of an example of a checkout page hosted on an online marketplace implementing features of the method shown in FIG. 2.

FIG. 8 is a flow diagram of a second example of a method for community-based customer rewards management.

FIG. 9 is an illustration of an example of a buyer and a seller performing features of the method shown in FIG. 8.

### DETAILED DESCRIPTION

The disclosed methods will become better understood through review of the following detailed description in conjunction with the figures. The detailed description and figures provide mere examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

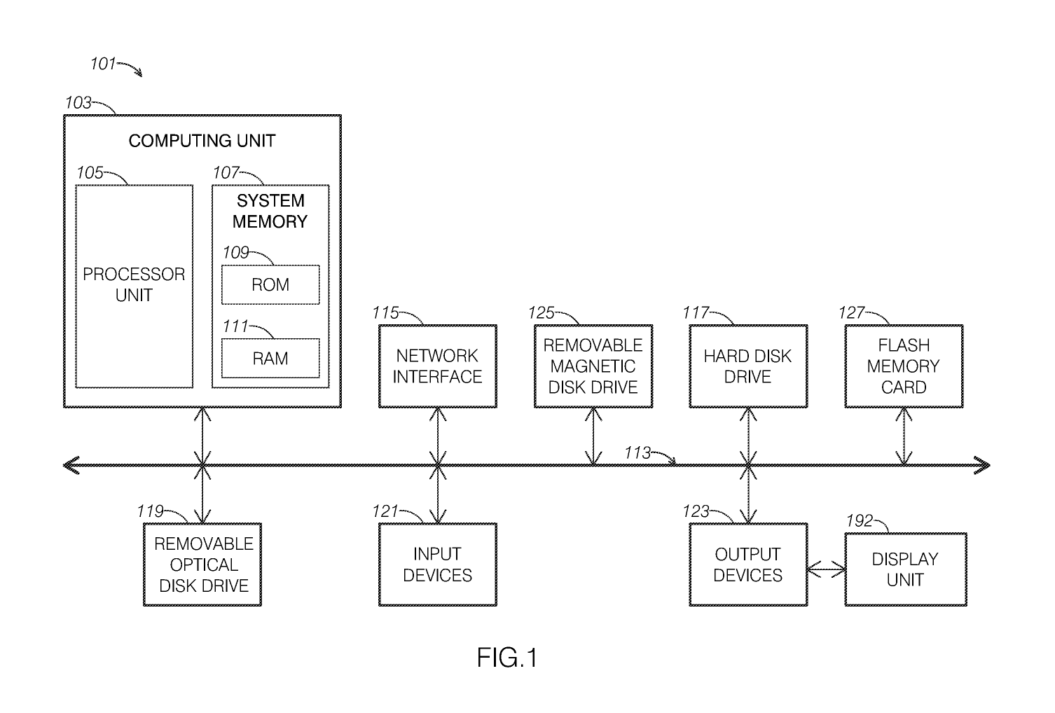

Accordingly, FIG. 1 shows one illustrative example of a computer 101 that can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 will be directly or indirectly connected to one or more network interfaces 115 for communicating with a network. This type of network interface 115, also sometimes referred to as a network adapter or network interface card (NIC), translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or iOS or Android based smartphone. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth® interface, a Wi-Fi interface, an infrared data port, or the like.

It should be appreciated that a computing device employed according various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

This disclosure describes methods that may, in some examples, be implemented as processor machine readable code that may be executed by a computing unit, similar to computer 101.

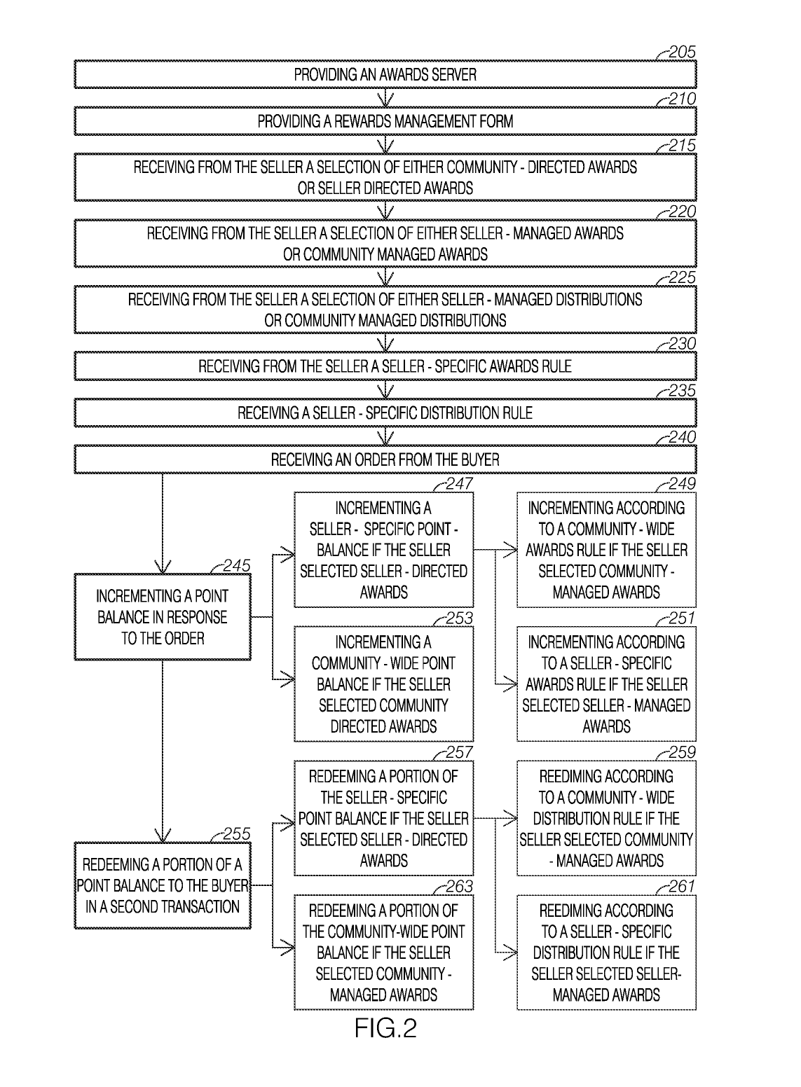

With reference to FIGS. 2-7, a first example of a method for community-based customer rewards management, method 200, will now be described. Method 200 includes providing a rewards server at step 205, providing a rewards management form at step 210, receiving from the a seller a selection of either community-directed awards or seller-directed awards at step 215, receiving from the seller a selection of either seller-managed awards or community-managed awards at step 220, receiving from the seller a selection of either seller-managed distributions or community-managed distributions at step 225, receiving form the seller a seller-specific awards rule at step 230), receiving a seller-specific distribution rule at step 235, receiving an order from a buyer at step 240, incrementing a point balance in response to the order at step 245, and redeeming a portion of a point balance to the buyer in a second transaction at step 255.

Method 200 electronically tracks rewards accumulated in an online marketplace context while advancing on many conventional rewards systems in several ways. For example, method 200 allows sellers to track customers' rewards on a seller-specific basis or share rewards with fellow members of a seller community. Method 200 further allows sellers and/or communities to customize the rules and criteria governing the way their rewards are distributed and awarded. In some examples, sellers may simply adopted the rewards system of a seller community of which they are a member, providing a simple, substantially hands-off rewards system.

In some examples, seller communities (or just “communities”) are groups of sellers on the online marketplace that are affiliated with one another as a “community.” In some examples, communities manage community-wide awards programs that implement features of method 200.

In some examples, community affiliations may identify groups formed amongst sellers without any type of governing body or organization. In such examples, a representative seller from the community may manage the community record, including the seller list, and invite other affiliated retailers to join the community. Often, this representative seller may also manage any community-wide rewards preferences for the community, such as community-wide awards rules and community-wide distribution rules.

In other examples, communities may be managed by third party governing bodies or organizations. For example, local groups, such as local chambers of commerce, may create and administer communities and determine which sellers are permitted to join. Such third parties manage the community record and community preferences on behalf of the community as a whole. Other communities may be defined by larger, national groups or accreditations as well, such as the Better Business Bureau and the like. Communities managed by third parties may, in some examples, rely on the administrator of the online marketplace and/or rewards server 300 to manage and administer the community preferences and the associated awards programs. In other examples, they may have a community management account on rewards server 300 with permissions to define community rewards preferences along with other community management and administration tasks.

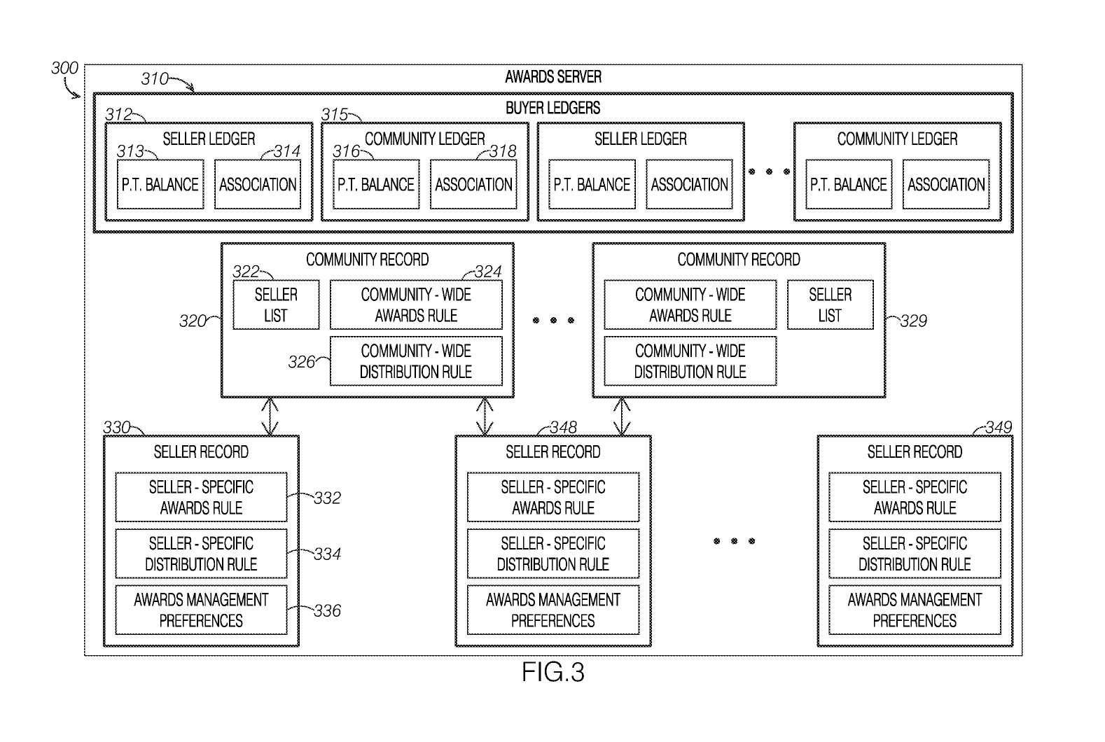

As FIG. 2 illustrates, a rewards server is provided at step 205. FIG. 3 diagrammatically illustrates an example of a rewards server, rewards server 300. As FIG. 3 illustrates, rewards server 300 may, based on the rewards systems currently being hosted by rewards server 300, include a ledger dataset 310, a community record 320, and a seller record 330. Rewards server 300 may also include one or more additional ledgers, community records, such as community records 329, and seller records, such as seller records 349.

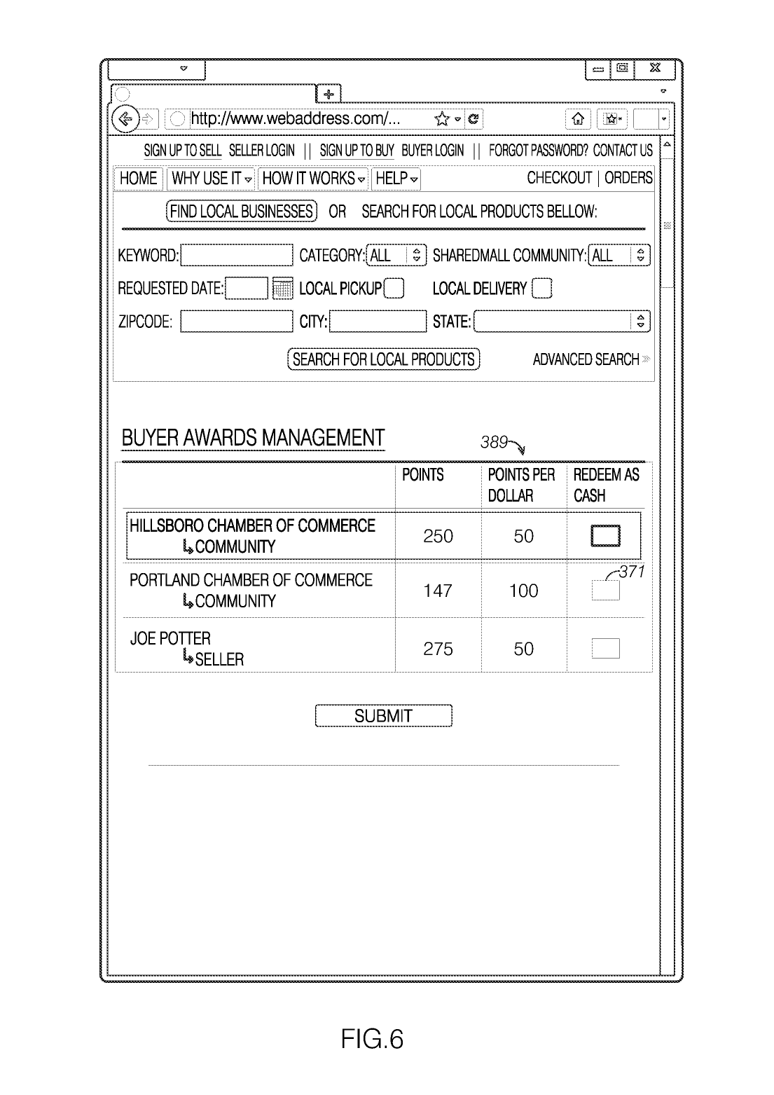

As FIG. 3 shows, ledger dataset 310 stores data corresponding to rewards points accumulated by the buyer. As FIG. 3 illustrates, ledger dataset 310 includes one or more ledgers, such as seller ledger 312 and community ledger 315. Ledger dataset 310 associates all of the ledgers associated with a buyer in a single dataset. Because each buyer may have a separate ledger associated with each community and/or seller from whom they purchase, many ledger datasets associated with buyers include multiple ledgers. Likewise, each seller or community may have any number of ledgers, as they may each have ledgers associated with numerous buyers. FIG. 6, for example, provides a buyer awards management form 395 showing a number of ledgers buyer has accumulated along with the corresponding sellers or communities.

Seller ledger 312, is configured to store a seller ledger entry 313 and a seller identification entry 314. Seller identification entry 314 includes identification data that identifies the seller offering products on the online marketplace from whom the buyer associated with ledger dataset 310 received rewards. Seller ledger entry 313 includes ledger data corresponding to a seller-specific point balance that denotes the amount of rewards received by the buyer associated with ledger dataset 310 from the associated seller. In some examples, seller ledgers may be associated with sellers that are members of seller communities.

As FIG. 3 illustrates, community ledger 315 includes a community ledger entry 316 ledger data corresponding to a community-wide point balance that denotes the amount of rewards received by the buyer associated with ledger dataset 310 from the associated community. As FIG. 3 illustrates, community ledger 315 additionally includes a community identification entry 318 that includes identification data identifying a seller community from whom the buyer associated with ledger dataset 310 received rewards.

As FIG. 3 illustrates, community record 321) includes a seller list 322, community-wide awards rule data 324, and community-wide distribution rule data 326. Seller list 322 defines which sellers are members of the associated community. In some examples, sellers must be listed on a community's seller list to enroll in community-managed awards with the community associated with community record 320.

Community-wide awards rule data 324 and community-wide distribution rule data 326 govern aspects of the operation of the associated community's rewards management system, specifically including the criteria determining the accumulation and distribution of rewards points. In some examples, the community or a representative thereof establishes and administers these rules on the online marketplace. Such representative may include, for example, an agent of the community, a managing-member of the community, a seller, or other party granted authority to manage the community's preferences on the online marketplace.

As FIG. 3 illustrates, rewards server 300 includes seller record 331) associated with a seller on the online marketplace. As FIG. 3 shows, seller record 330 includes seller-specific awards rule data 332 and seller-specific distribution rule data 334 that govern aspects of the operation of the associated seller's rewards management system, specifically including the criteria determining the accumulation and distribution of rewards points. As FIG. 3 illustrates, seller record 33) additionally includes rewards management preferences data 336 that stores whether the seller prefers community managed and directed awards or seller managed and directed awards. The rewards management preferences data often indicates several key preferences of the seller relating to rewards management. First, the rewards management preferences data often indicates whether the seller has chosen to participate in a community rewards program or to create and administer her own rewards program. Further, the rewards management preferences data may indicate whether the seller has chosen to adopt community-wide distribution and/or awards rules or to create and administer her own rules.

In some examples, the rewards management preferences may indicate that the seller chooses to have community-directed awards while adopting seller-specific awards and/or distribution rules. This may occur, for example, when a seller hosts a sale or similar event (often with community approval), whereby the seller rewards more points than the community-specified rate. Further, the rewards management preferences data may indicate seller-directed awards while indicating community-wide awards and distribution rules. This may occur, for example, when a seller would like to have an individually targeted rewards program while outsourcing purchase from the seller accumulate awards in a seller ledger associated with the seller or a community ledger associated with a community in which the seller is a member, and whether awards should be accumulated according to seller-specific awards and distribution rules or community-wide awards and distribution rules.

Sellers may be members of one or more communities on the online marketplace. For example, FIG. 3 illustrates that seller record 330's seller is a member of community record 320's community. As FIG. 3 further illustrates, seller record 348 is a member of two communities: those associated with community record 320 and community record 329. As seller record 349 further illustrates, sellers are not even required to be members of communities at all.

The data structure and flow diagrams illustrated in FIG. 3 are provided for clarity only. Embodiments of the inventive subject matter need not store and communicate data in the precise manner illustrated in FIG. 3, and many embodiments may organize the data in ways that dramatically differ from the organization shown in FIG. 3. For clarity's sake, however, many foregoing examples in this detailed description will be discussed in connection with the data stored and communicated according to the diagrams FIG. 3.

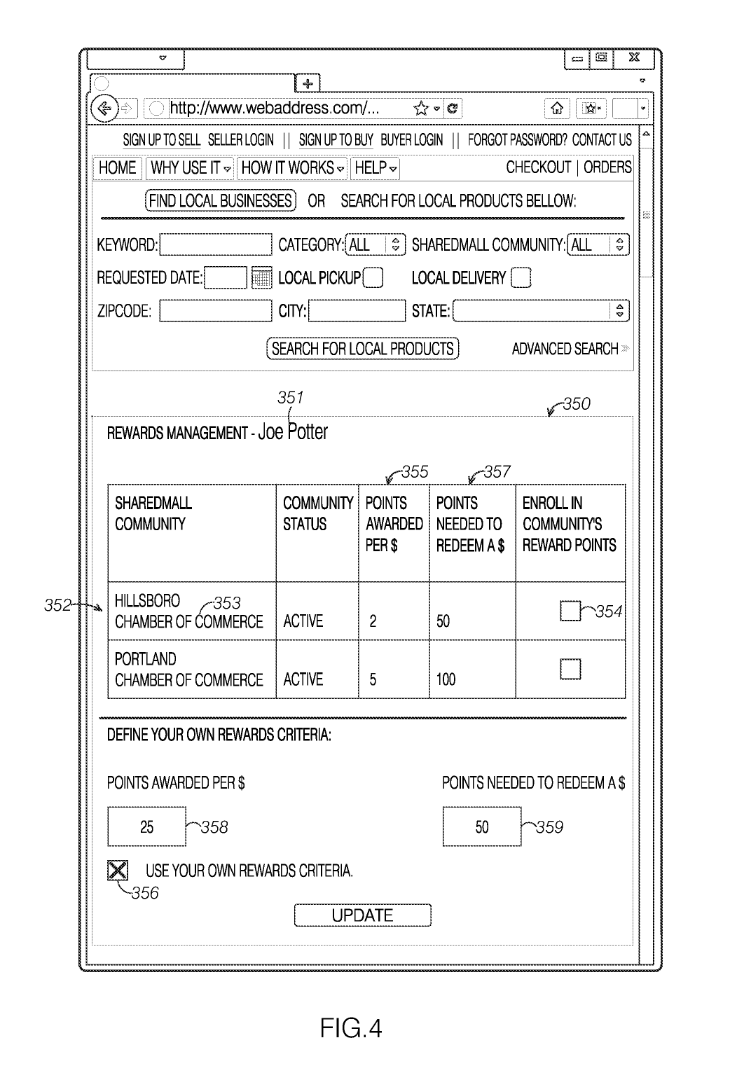

As FIG. 2 illustrates, a rewards management form is provided at step 210. FIG. 4 illustrates an example rewards management form, form 350. As FIG. 4 illustrates, form 350 includes a community list 352, a community-management selection entry 354, a seller-management selection entry 356, a seller-specific awards entry 358, and a seller-specific distribution entry 359. Form 350 allows a seller 351, to manage preferences associated with his rewards program. For example, form 350 allows seller 351 to choose whether to participate in the rewards program of the communities in which he is a member and to administer a seller-specific rewards program, including the management of awards and distribution rules.

As FIG. 3 illustrates, community list 352 displays the communities in which the seller is a member. As FIG. 3 shows, community list 352 further displays the awards and distribution rules associated with each community, listed in the an awards column 355 and a distributions column 357, respectively. Further, community list 352 includes one or more community-management selection entries that allows seller 351 to participate in the community-managed rewards program associated with the selected community. For example, community-management selection entry 354 allows seller 351 to participate in the awards program of a listed community 353, thereby selecting community-directed awards directed to a community ledger associated with community 353. In some examples, selecting community-managed awards in this manner additionally selects community-managed awards and distributions.

As FIG. 3 shows, form 350 additionally allows sellers to manage their own seller-specific rewards program. By selecting seller-management selection entry 356, seller 351 may select to manage a seller-specific rewards program rather than any community rewards program. By selecting seller-management selection entry 356, seller 351 selects seller-directed rewards, and rewards earned by his buyers are directed to a seller ledger associated with seller 351 specifically. Further, selecting seller-management selection entry 356 allows seller 351 enter his own awards and distributions rules. For example, form 350 includes seller-specific awards entry 358 that allows seller 351 to enter a seller-selected ratio of award points received per purchase price of a purchased product and seller-specific distribution entry 359 similarly allows seller 351 to enter a seller-selected ratio of awards points to a redemption amount in dollars.

As FIG. 2 illustrates, a selection of either community-directed awards and seller-directed awards is received from the seller at step 215. By selecting community-directed awards, a seller directs buyers' rewards from that seller to be stored in a community ledger associated with a selected community rather than a seller ledger associated with the seller specifically. A seller could select community-directed awards, for example, by selecting a community-management selection entry, such as community-management selection entry 354. Similarly, a seller could select seller-directed awards by selecting a seller-management selection entry, such as seller-management selection entry 356. When rewards are stored in a community ledger, they may generally be redeemed through members of the community participating in the community's rewards program. In some cases, however, sellers may redeem community-directed awards even though they are not participating in the community's rewards program. This may happen, for example, when sellers are members of a community and manage a seller-specific rewards program while wanting to draw in customers from the community's rewards program. Likewise, funds stored in seller ledgers often must be redeemed through the seller associated with the ledger, but may be applied towards other sellers or communities as well.

As FIG. 2 shows, a selection of either seller-managed awards and community-managed awards is received from the seller at step 220. Seller may select between seller-managed and community-managed awards, for example, by selecting either seller-management selection entry 356 or community-management selection entry 354. By selecting seller-managed awards, seller determines that rewards accumulated from his sales increment an associated ledger entry according to a seller-specific awards rule. The seller-specific awards rule may be specified in seller-specific awards entry 358, for example. For example, seller 351 entering “25” in seller-specific awards entry 358 dictates that buyers' associated ledger entries should be incremented by 25 rewards points for every dollar spent with the seller.

Similarly, by selecting community-managed awards, seller determines that rewards accumulated from his sales increment an associated ledger entry according to a seller-specific awards rule. For example, FIG. 4 illustrates several examples of community-wide awards rules and their associated communities in awards column 355. In some examples, sellers may choose to apply these awards rules by selecting the associated community-management selection entries. In some examples, sellers may apply multiple rules when participating in multiple community-managed rewards programs.

As FIG. 2 shows, a selection of either seller-managed distributions or community-managed distributions is received from the seller at step 225. Sellers' distribution preferences govern the way reward points are redeemed, often by dictating the amount of points required to redeem a unit of value. A seller may select distribution management preferences, for example, by selecting seller-management selection entry 356 to select seller-managed distributions or community-management selection entry 354 to select community-managed distributions. By selecting seller-managed awards, seller directs that buyers' accumulated rewards points should be distributed according to a seller-specific distribution rule. For example, by entering “50” in seller-specific distribution entry 359, seller directed that buyers may redeem rewards points at the rate of $1 per 50 points.

Similarly, if a seller selects community-managed distributions, then awards are distributed according to a community-wide distribution rule. FIG. 4 illustrates several examples of community-wide distribution rules in distributions column 357. Sellers may select one of the displayed rules to apply by selecting a community-management selection entry, such as community-management selection entry 354 to dictate that one dollar should be distributed for every 50 points redeemed. In some examples, sellers are bound by the specific terms of the community-wide award and distribution rules when participating in a community-managed rewards program, but this is not specifically required.

As FIG. 4 illustrates, a seller-specific awards rule may be received from the seller at step 230. FIG. 4 illustrates such an example: seller 351 has entered in a custom awards rule in seller-specific awards entry 358, indicating that 25 awards points are to be received for every dollar spent. Likewise, a seller specific distribution rule may be received from the seller at step 235. As FIG. 4 illustrates, this occurs substantially similarly to receiving the seller-specific awards rule: seller 351 may enter a seller-specific distribution rule in seller-specific distribution entry 359.

In some examples, sellers may enter awards and/or distribution management rules more complex than mere ratios. For example, sellers may attach different ratios to certain products or categories of products to highlight those products by offering “bonus” rewards for those products or categories. Communities may also enter such varied rules. As a community-specific example, communities may, at times, attach varying ratios to different members of the communities. This may be useful, for example, to drive sales towards particular community members. Such different ratios may be similarly applied to distributions as well.

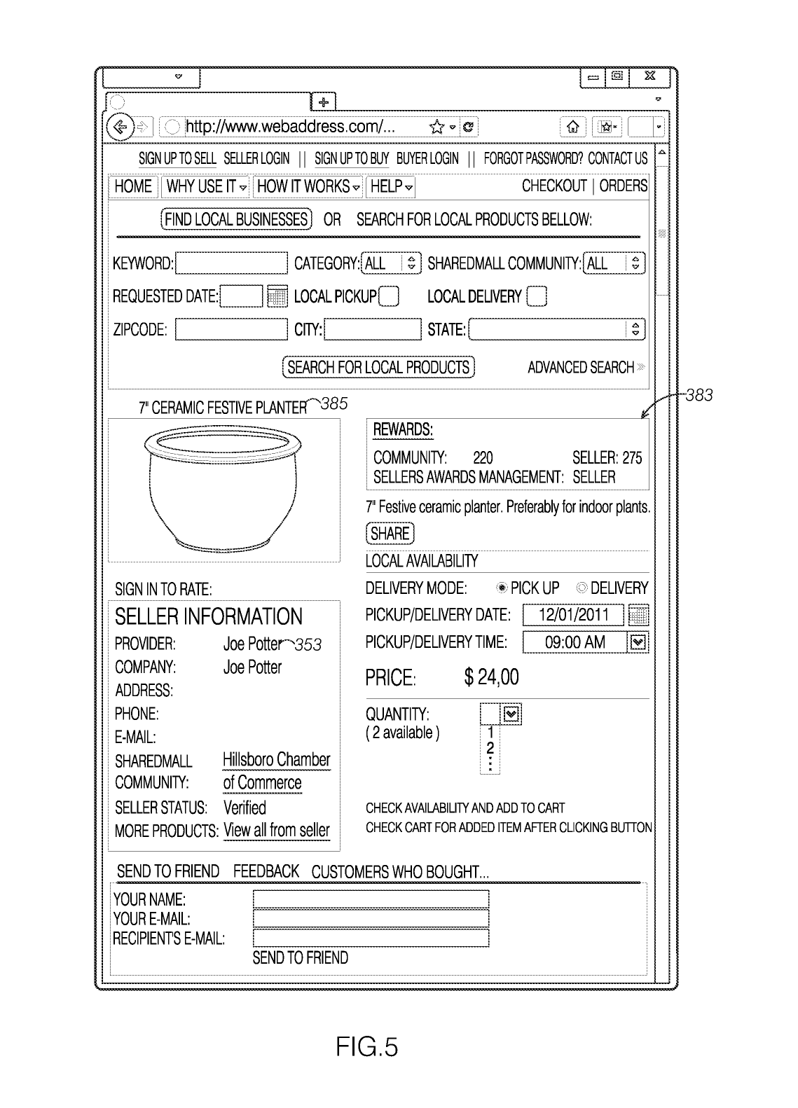

As FIG. 2 illustrates, an order is received from a buyer in a transaction at step 240. The order is directed toward a seller and defines a purchase price associated with the order. FIG. 5 illustrates an example product page on an online marketplace, through which a buyer may make an order. As FIG. 5 illustrates, product pages and/or order forms may include a rewards status display 383 that allows buyers to know precisely how much he can expect to expend via rewards.

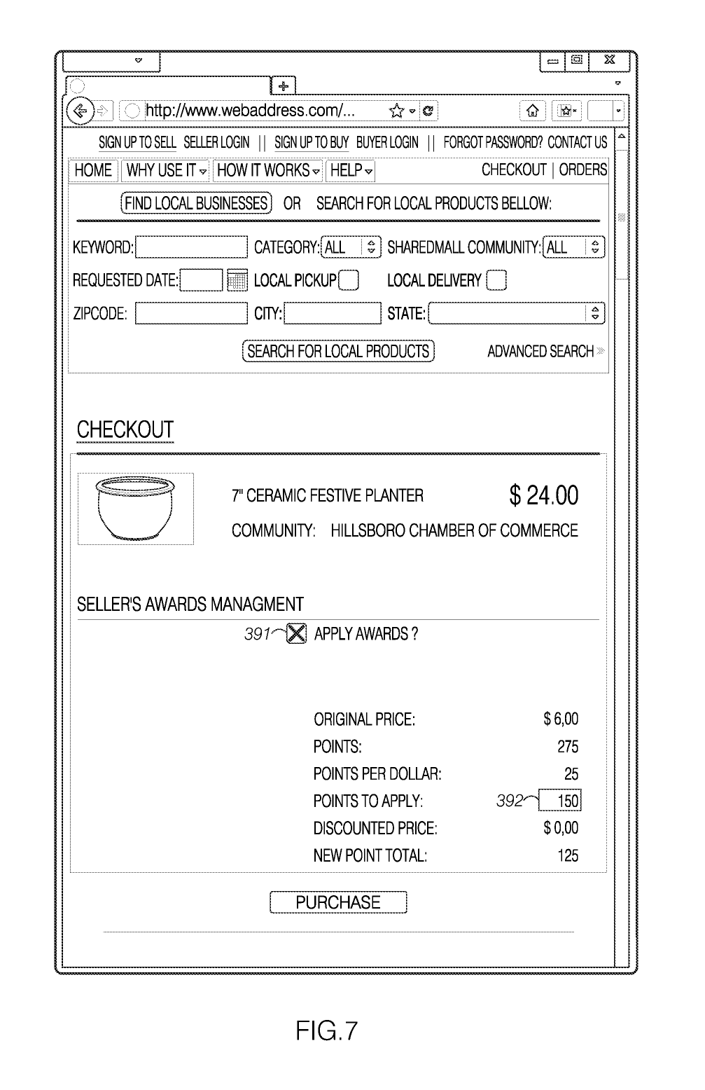

FIG. 7 illustrates an example of a checkout page from a buyer purchasing a product. As FIG. 7 shows, the buyer purchased a product originally having a price of $24. As FIG. 7 shows, however, the purchase price was discounted to $21. This $21 purchase price is used to calculate the amount of rewards points awarded for the sale.

As FIG. 2 illustrates, the point balance stored in a ledger entry is incremented in response to the order at step 245. The appropriate ledger entry is determined and incremented based on sellers' awards management preferences. For example, the ledger entry of a seller ledger associated with a seller may be incremented if the seller selects seller-directed awards at step 247. For example, FIG. 7 illustrates a checkout page that wherein a buyer is making a purchase from seller 351, who selected seller-directed awards. Accordingly, a seller ledger associated specifically with seller 351 will be incremented as a result.

If the seller selected seller managed awards, is incremented according to a seller-specific awards rule at step 251. As FIG. 4 illustrates, seller 351 selected seller-managed awards. As a result, a seller ledger associated with seller 351 will be incremented according to the seller-specific awards rule entered in seller-specific awards entry 358 as buyers purchase from him. In some cases, however, the seller ledger may be incremented according to a community-wide awards rule at step 249. In such a case, a seller may have selected seller-directed awards, yet also selected community-managed awards, wherein the seller merely adopts the community's award management rules while tracking the buyer's awards in a ledger specific to the seller.

As FIG. 2 shows, a community-wide point balance is incremented if the seller selected community-directed awards at step 253. Reward points received in response to orders from sellers who select community-directed award are in stored a community ledger associated with the community, rather than the seller specifically. In some cases, the seller may select the particular community to manage their awards by selecting a community-management selection entry on a rewards management form. As FIG. 4 shows, seller 351 is a member of multiple communities and selected community-management selection entry 354, thereby directing rewards to a community ledger associated with the “Hillsboro Chamber of Commerce.”

In cases where a seller selects community-directed awards, community-managed awards are often applied by default. However, some examples may allow sellers to define their own award rules applied to their sales even when they have selected community-directed awards. In such cases, reward points would be stored in a community ledger associated with a community, but points would be incremented according to the seller's specific awards rules.

As FIG. 2 illustrates, a portion of the point balance of a point balance is redeemed to the buyer at step 255. Depending on sellers' rewards management preferences, points may be redeemed from a seller-specific point balance stored in a seller ledger or a community-wide point balance stored in a community ledger. If the seller selected seller-managed distributions, a portion of the seller-specific point balance stored in a seller ledger associated with a seller may be redeemed to a buyer at step 257.

In some such examples, the points are redeemed to the buyer in the form of a discount of the purchase price of a product purchased from the seller. FIG. 7 illustrates an example wherein a buyer has redeemed a discount of a product originally priced at $24. As FIG. 7 shows, the buyer has selected to redeem a portion of his points to be redeemed by selecting awards redemption entry 391. Specifically, the buyer selected to redeem “150” rewards points a redemption amount entry 392. As FIG. 7 shows, 150 points are removed from the appropriate point balance and a $3 discount is applied the purchase price of the buyer's product (reflecting the $1 per 50 points ratio directed by the seller-specific distribution rule entered by seller 351).

As FIG. 7 illustrates, buyers are not required to redeem all of his awards points in a single transaction; rather, buyers are able to enter any amount in redemption amount entry 392 to redeem that amount of rewards points. As FIG. 7 further illustrates, buyers are able to accumulate additional points even when discounts are applied to purchases. As FIG. 7 shows, the buyer accumulates additional rewards points in response to paying the remainder of the discounted price.

As FIG. 2 shows, if a seller selects community-managed distributions, points may be redeemed from a seller ledger according to a community-wide distribution rule at step 259. In such a case, the points are redeemed substantially similar to the process described above. Community-wide distribution rules are applied rather than seller-specific distribution rules, however.

As FIG. 2 shows, points may be redeemed from a community ledger according to a community-wide distribution rule if the seller selected community-directed awards at step 261. If the seller indicated community-directed awards, points are redeemed from community ledger associated with the community as a whole, rather than a seller ledger associated only with seller specifically. Because many communities do not typically sell products themselves, redemption of community points are often performed by a redeeming agent acting on behalf of the community.

In some examples, the redeeming agent may be the same seller from whom the buyer originally purchased. In such cases, points are redeemed substantially as described above.

In other examples, the redeeming agent may be a redeeming seller that is a member of the same community, but distinct from, the original seller. In such cases, the points may be redeemed according to the community-wide distribution rule, typically as a discount applied to their product. For example, FIG. 6 illustrates an example wherein a buyer has accumulated 250 points from the “Hillsboro Chamber of Commerce” community, which includes multiple sellers. In some examples, buyers may redeem points in the corresponding community ledgers as discounts from any participating seller in the “Hillsboro Chamber of Commerce,” even if that is not the same seller in which the buyer earned the rewards. Such redemptions often occur according to the community-wide distribution rules, but sellers may, in some examples, define their own redemption rate for community rewards.

Sellers may, in some cases, elect to redeem points on behalf of a community, even if they have chosen seller-directed or seller-managed awards and/or distributions. For example, seller 351 has selected seller-managed and directed awards and distributions. In some cases, seller 351 may select to discount products in response to buyers redeeming rewards points from a community-wide ledger associated with the Hillsboro Chamber of Commerce even though seller 351 selected seller-managed and directed rewards.

In some examples, buyers may redeem points with the redeeming agent and receive cash, check, or other form of direct payment. The redeeming agent may, in such examples, be the administrator of the online marketplace and/or rewards server 300, a user account on rewards server 300 operated by the community or a community representative, the community itself, or any other person authorized to act or pay on behalf of the community. FIG. 6 illustrates an example of a cash redemption form 389 through which a buyer may redeem community points in the form of direct payment. As FIG. 6 shows, the buyer may select to redeem his points as cash by selecting a cash redemption selection entry 371 associated with the community and submitting the associated form to rewards server 300.

As FIG. 6 illustrates, some communities and/or sellers may choose not to allow redemptions in the form of direct payment. As FIG. 6 illustrates, certain cash redemption selection entries may be grayed or otherwise displayed as inactive to indicate to buyer that the associated seller or community does not allow redemption in the form of direct payment.

In some examples, sellers that have selected seller-directed or managed awards/distributions may appoint a redeeming agent that redeems points in the form of direct payment, similar to communities' redeeming agents.

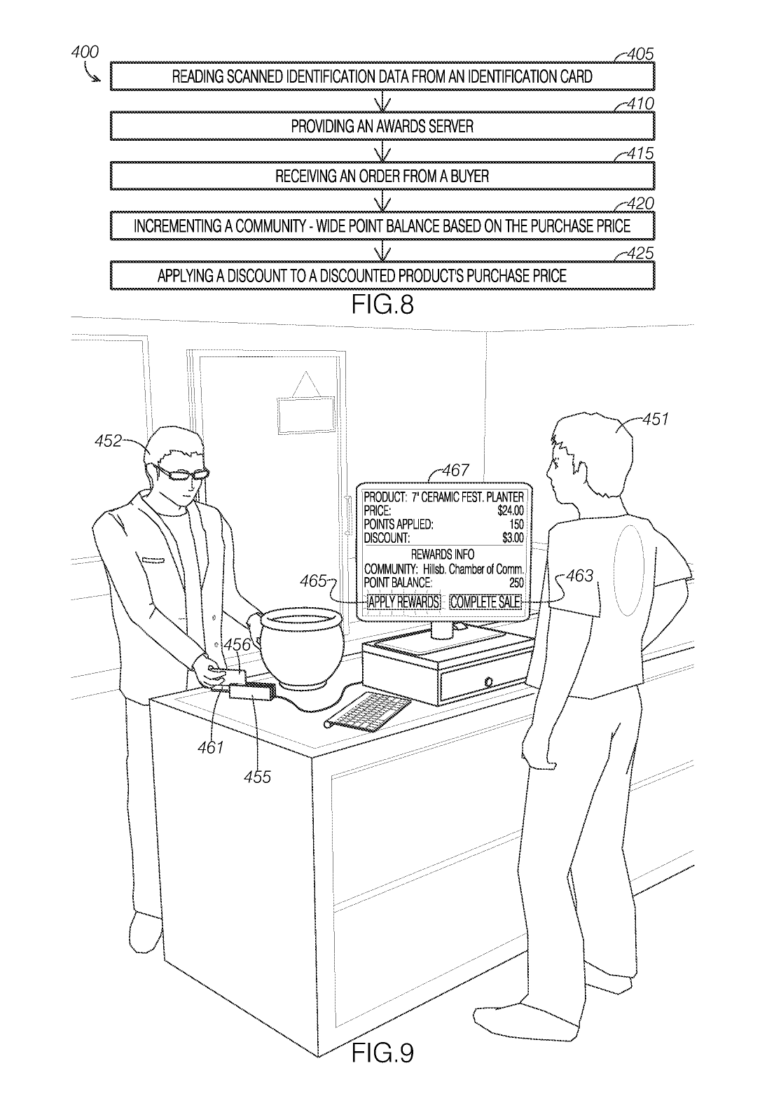

With reference to FIG. 8, a second example of a method for community-based customer rewards management, method 400, will now be described. Method 400 includes many similar or identical features to method 200 combined in unique and distinct ways. Thus, for the sake of brevity, each feature of method 400 will not be redundantly explained. Rather, key distinctions between method 200 and method 400 will be described in detail and the reader should reference the discussion above for features substantially similar between the two methods.

As FIG. 8 illustrates, method 400 defines a method for community-based customer rewards management and includes many of the features of method 200 augmented with identification card features that may be operated in physical locations of local retailers. Whereas many transactions relating to method 200 occur on an online marketplace, transactions relating to method 400 often occur at local retailers' physical address.

As FIG. 8 illustrates, method 400 includes the steps of reading scanned identification data from an identification card at step 405, providing a rewards server at step 410, receiving an order from a buyer at step 415, incrementing a community-wide point balance based on the purchase price at step 420, and applying a discount to a discounted product's purchase price at step 425. FIG. 9 illustrates a buyer and seller performing some features of method 400.

By featuring identification cards with encoded data, methods similar to method 400 allow sellers and communities to establish consumer rewards programs similar to method 200's that may be applied to in-person transactions. This may be useful, for example, for sellers that are members of a community on an online marketplace, but still complete a portion of their sales through local pickup or in-person transactions. Further, many sellers do a portion of their business through walk-in traffic without any connection to their online presence; this provides a way to link those sales with rewards balances hosted on a rewards server.

The rewards server hosted at step 410 is substantially similar to rewards server 300.

Scanned information data is read from an identification card reader at step 405. The identification card reader is configured to scan encoded identification data from a community identification card. FIG. 9 illustrates an example wherein a seller 451 scans a buyer 452's community identifier 456, community identifier 456 defining a plastic identification card, with a community identification reader 455, community identification reader 455 defining a card reader connected to a point-of-sale computing device 467. Community identifier 456 includes encoded identification data on a magnetic strip 461 that identifies buyer 452 and an identified community that includes seller 451. Community identification reader 455 is configured to translate the data encoded on magnetic strip 461 and communicate the data to point-of-sale computing device 467. Upon reading the encoded data, seller 451 may access the rewards server using point-of-sale computing device 467 to access a community ledger associated with buyer 452 and the community identified by the encoded data. As the example illustrates, buyer 452's card indicates that the seller is a member of the “Hillsboro Chamber of Commerce” community. Although data is encoded on community identifier 456 as a magnetic strip, other presently understood methods of encoding data are equally within this disclosure, such as QR codes, RFID tags, as bar codes. Further, community identification displays need not be cards. For example, other community information displays may define other portable implements, mobile electronic devices or other implements including electronic or physical displays that are capable of displaying or otherwise conveying the encoded data.

As FIG. 8 illustrates, an order is received from the buyer at step 415. The order, in this case, is often received by sellers at their physical store locations. The order defines a purchase price, defining the amount at which buyer 452 purchases a product or products from seller 451. As FIG. 9, the purchase price may be discounted using the rewards account accessed using community identifier 456, similar to the transaction illustrated in FIG. 7. As FIG. 9 shows, seller 451 does in fact discount the purchase price in this example.

As FIG. 8 shows, a community-wide point balance is incremented based on the purchase price at step 420. Upon completing a sale, seller 451 may communicate the purchase price to the rewards server along with buyer and/or community identification data and request the rewards server to increment the community-wide point balance of a community ledger associated with a community indicated by the encoded data on community identifier 456. Often the seller is participating in a community-rewards program managed by the community indicated by community identifier 456. For example, seller 451 could increment the community ledger by selecting a complete sale button 463 on a point-of-sale computing device that completes the sale and requests rewards server to increment the appropriate community-wide point balance. The community-wide point balance may be, but is not required to be, incremented according to the community's rewards management preferences (including any community-wide awards rules).

As FIG. 8 illustrates, a discount is applied to a discounted product's purchase price at step 425. For example, seller 451 may select an apply balance button 465 on a point-of-sale computing device to apply a portion of buyer 452's accumulated rewards to a present sale. As FIG. 9 shows, buyers may request sellers to redeem any portion of their rewards points balance that they select. In some examples, buyers may redeem rewards at a redeeming seller that is distinct from the seller they originally accrued reward points from but a member of a community managing a community-wide rewards program in which seller is participating. In some examples, buyers may redeem points awarded at sellers' physical locations on an online marketplace in which the seller and/or community manages a rewards program.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for distributing a reward to a buyer purchasing a product on an online marketplace, the method comprising:
providing a rewards server storing:
a community ledger including:
a community identification entry including identification data identifying a seller community; and
a community ledger entry including ledger data corresponding to a community-wide point balance; and
a seller ledger including:
a seller identification entry including identification data identifying a seller on the online marketplace; and
a seller ledger entry including ledger data corresponding to a seller-specific point balance; and
executing with a processor machine readable code that instructs a computing device to perform the steps of:
receiving an order from the buyer, the order directed to the seller and defining a purchase price;
receiving from the seller a selection of either community-directed awards or seller-directed awards;
incrementing the seller-specific point balance if the seller selected seller-directed awards; and
incrementing the community-wide point balance if the seller selected community-directed awards.

2. The method of claim 1, further comprising executing with the processor machine readable code that instructs the computing device to perform the step of providing a rewards management form including a community-management selection entry that allows the seller to select community-directed awards.

3. The method of claim 1, further comprising executing with the processor machine readable code that instructs the computing device to perform the step of providing a rewards management form including a seller-management selection entry that allows the seller to select seller-directed awards.

4. The method of claim 1, further comprising executing with the processor machine readable code that instructs the computing device to perform the step of receiving from the seller a selection of either seller-managed awards or community-managed awards, wherein:
incrementing the seller-specific point balance includes incrementing the seller-specific point balance according to a community-wide awards rule if the seller selected community-managed awards; and
incrementing the seller-specific point balance includes incrementing the seller-specific point balance according to a seller-specific awards rule if the seller selected seller-managed awards.

5. The method of claim 4, further comprising executing with the processor machine readable code that instructs the computing device to perform the step of receiving from the seller the seller-specific awards rule including a seller-selected ratio of purchase price to points earned.

6. The method of claim 5, further comprising executing with the processor machine readable code that instructs the computing device to perform the step of providing a rewards management form including a seller-specific awards entry that allows the seller to enter the seller-selected ratio of purchase price to points earned.

7. The method of claim 1, further comprising executing with the processor machine readable code that instructs the computing device to perform the steps of:
receiving from seller a selection of either seller-managed distributions or community-managed distributions;
redeeming a portion of the seller-specific point balance to the buyer according to a seller-specific distribution rule if the seller selected seller-managed distributions; and
redeeming a portion of the seller-specific point balance to the buyer according to a community-wide distribution rule if the seller selected community-managed distributions.

8. The method of claim 7, wherein the seller-specific distribution rule includes a seller-selected ratio of points to redemption amount.

9. The method of claim 8, further comprising executing with the processor machine readable code that instructs the computing device to perform the step of providing to the seller a rewards management form including a seller-specific distribution entry that allows the seller to enter the seller-selected ratio of points to redemption amount.

10. The method of claim 7, wherein the portion of the seller-specific point balance redeemed to the buyer is redeemed as a discount applied to a discounted product's purchase price, the discounted product purchased from the seller by the buyer in a second transaction.

11. The method of claim 10, further comprising executing with the processor machine readable code that instructs the computing device to perform the step of incrementing the seller-specific point balance by applying a seller-specific awards rule to the discounted product's purchase price.

12. The method of claim 7, wherein:
the portion of the seller-specific point balance redeemed to the buyer according to the community-wide distribution rule defines a discount applied to the purchase price of a discounted product's purchase price, the discounted product purchased from a redeeming seller by the buyer, and
the redeeming seller and the seller are distinct and are members of the seller community.

13. The method of claim 1, further comprising executing with the processor machine readable code that instructs the computing device to perform the step of redeeming a portion of the community-wide point balance to the buyer according to a community-wide distribution rule if the seller selected community-directed awards.

14. A method for distributing an award to a buyer purchasing a product on an online marketplace, the method comprising:
providing a rewards server storing a community ledger, the community ledger including:
a community identification entry including identification data identifying a seller community; and
a community ledger entry including ledger data corresponding to a community-wide point balance; and
executing with a processor machine readable code that instructs a computing device to perform the steps of:
receiving an order from the buyer and directed to a seller that is a member of the seller community and defining a purchase price;
incrementing the community-wide point balance based on the purchase price, wherein the community-wide point balance is incremented according to a community-wide awards rule; and
redeeming a portion of the community-wide point balance to the buyer in a second transaction, the second transaction being between the buyer and a redeeming agent associated with the seller community.

15. The method of claim 14, wherein the redeeming agent defines a redeeming seller that is a member of the seller community and is distinct from the seller.

16. The method of claim 15, wherein:
the order defines a first order, and
the second transaction includes a second order from the buyer that reflects a discounted purchase price calculated from the community-wide point balance and a community-wide distribution rule.

17. The method of claim 15, wherein:
the order defines a first order, and
the second transaction includes a second order from the buyer that reflects a discounted purchase price calculated from the community-wide point balance and a seller-specific distribution rule.

18. The method of claim 14, wherein the redeeming agent provides cash to the buyer in the second transaction.

19. (canceled)

20. (canceled)
